(19) United States
(12) Patent Application Publication
(10) Pub. No.: US 2023/0350733 A1
(43) Pub. Date: Nov. 2, 2023

(54) VIRTUAL MACHINE CLUSTER PLACEMENT IN A CLOUD ENVIRONMENT

(71) Applicant: Oracle International Corporation, Redwood Shores, CA (US)

(72) Inventors: Nagarajan Muthukrishnan, San Ramon, CA (US); Prasanna Ramamurthi, Bangalore (IN); Niloy Banerjee, Cupertino, CA (US); Binoy Sukumaran, Foster City, CA (US)

(21) Appl. No.: 17/730,883

(22) Filed: Apr. 27, 2022

(51) Int. Cl. G06F 9/50; G06F 15/173; G06F 11/34

(52) U.S. Cl. CPC G06F 9/5077; G06F 9/5044; G06F 15/17331; G06F 11/3409

(57) ABSTRACT

Techniques are described herein for automatically determining optimal placement for VM clusters in multi-device infrastructure. Potential combinations of host nodes for a VM cluster are selected based on applicable constraints on host nodes for the cluster. Further, applicable optimization criteria (OC) for the VM cluster and/or the infrastructure are formally defined and modeled for automatic performance. Application of this placement model to the potential combinations of host nodes results in one or more OC metrics that may be directly compared so that alternate potential host node combinations may be ranked based on the determined OC metrics. The highest-ranked node combination is identified as the optimal VM cluster placement. The placement model can be used to implement initial, incremental, shuffling, or scaling placements of VM clusters. Further, hierarchical decisions may be made based on the determined OC metrics, allowing for application of the placement model to large and complex infrastructures.

### CROSS-REFERENCE TO RELATED APPLICATIONS

This application is related to U.S. application Ser. No. 17/577,729, filed Jan. 18, 2022, titled “Dynamic Hierarchical Placement of Consolidated and Pluggable Databases in Autonomous Environments” (Attorney Docket No. 50277-5821), and to U.S. application Ser. No. 17/334,360, filed May 28, 2021, titled “Resilience Based Database Placement In Clustered Environment” (Attorney Docket No. 50277-5764), the entire contents of each of which is hereby incorporated by reference as if fully set forth herein.

### FIELD OF THE INVENTION

The present invention relates to placement of virtual machine clusters on a multi-device system, such as a cloud environment, and more particularly, to automatically and efficiently provisioning virtual machine clusters spanning multiple devices in a computing system.

### BACKGROUND

In complex cloud environments, hundreds or even thousands of virtual machine (VM) clusters are provisioned for customers of services provided by the environments. A VM cluster may be of any size, such as from two VMs to 32 VMs, which work together to implement one or more applications. Based on subscription levels and service level agreements of a given customer, cloud environments can provide various levels of compute resources for VM clusters, including allocating to a VM cluster a dedicated rack of compute nodes, a group of racks isolated physically, one or more individual compute nodes, a portion of the resources of a compute node that is shared with one or more other VMs, and/or one or more isolated containers within a single compute node.

Identifying placements for VM clusters that satisfy all requirements applicable to the VM clusters, and that make optimal use of the computing infrastructure, can be challenging. Specifically, the provisioning of VM clusters can be complicated by requirements of the applications being implemented by the VM clusters or by requirements of the customers themselves. For example, a customer may require that their VM clusters be provisioned on compute nodes that have particular types of hardware/software. As a further example, for VM clusters implementing high-performance autonomous database services, a maximum number of VMs may be placed on a given compute node of the infrastructure to ensure that the VMs are able to adequately access compute node resources. VM clusters in a multi-tenant infrastructure generally also require resource isolation to satisfy performance requirements and to avoid noisy neighborhood problems. Also, the continued availability of VM cluster applications in the event of planned and unplanned downtime of compute nodes, such as during security patching or infrastructure failure, within the cloud environment is generally of high importance.

In addition to any application and customer requirements for VM cluster placement, administrators of the target infrastructure generally also have requirements for optimal utilization and maintenance of the infrastructure, including placing VMs in a way that aids ingestion of new hardware and phasing-out of outdated hardware over time. The administrator requirements may involve distribution of allocated resources across the computing devices (“nodes”) of a computing infrastructure, and potentially across NUMA sockets within compute nodes, which distribution changes over time. Also, the nodes of a computing infrastructure are generally heterogeneous, having different flavors and different generations of hardware throughout the infrastructure. The heterogeneity of compute nodes in the target infrastructure may further affect optimal placement of a VM cluster.

There are various methods used in the industry for VM cluster provisioning, which generally involve static heuristic algorithms to identify VM cluster placement. Moreover, VM cluster placement decisions are generally made based on where VM clusters are able to be placed considering available computing resources, and may not consider application requirements and/or administrator goals for infrastructure maintenance.

Thus, it would be beneficial to automatically place VM clusters within a multi-node computing infrastructure, where the placement decisions account for heterogeneous hardware, and for the various types of requirements applicable to the VM clusters and to the computing infrastructure.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 depicts an example computing system comprising a plurality of computing devices arranged as sets of tightly-interconnected computing devices.

FIG. 2A depicts virtual machines provisioned within a set of tightly-interconnected computing devices.

FIG. 2B depicts an unprovisioned virtual machine cluster comprising two virtual machines.

FIG. 3 depicts a flowchart for provisioning a virtual machine cluster within a computing system with multiple compute nodes.

FIG. 4 depicts the affinities of CPUs allocated to the VMs on compute nodes with regard to two NUMA sockets for each of the nodes.

FIG. 5 depicts a directed acyclic graph with workflow steps for placement of a virtual machine cluster.

FIG. 6 is a block diagram that illustrates a computer system upon which an embodiment may be implemented.

FIG. 7 is a block diagram of a basic software system that may be employed for controlling the operation of a computer system.

### DETAILED DESCRIPTION

In the following description, for the purposes of explanation, numerous specific details are set forth in order to provide a thorough understanding of the techniques described herein. It will be apparent, however, that the techniques described herein may be practiced without these specific details. In other instances, well-known structures and devices are shown in block diagram form in order to avoid unnecessarily obscuring the techniques described herein.

### 1. General Overview

Techniques are described herein for automatically determining optimal placement for virtual machine (VM) clusters among the computing devices of a multi-device computing infrastructure, such as a cloud computing infrastructure. The described VM cluster placement techniques take into account requirements of applications being implemented by the VM clusters, as well as requirements of the customers, and maintenance and optimization goals (termed herein “optimization criteria”) for the infrastructure itself. More specifically, potential combinations of host nodes for a VM cluster placement are selected based on applicable constraints on host nodes for the cluster. Further, applicable optimization criteria for the VM cluster and/or for the target infrastructure are formally defined and modeled in a placement model for automatic performance by a computing device. Application of this placement model to the various potential combinations of host nodes for the VM cluster results in one or more optimization criteria metrics that may be directly compared so that alternate potential host node combinations may be ranked based on the determined optimization criteria metrics. The highest-ranked node combination is identified as the optimal VM cluster placement.

In addition to optimal initial placement of a new VM cluster, the placement model is configured to be used to identify incremental placements that involve adding one or more VMs to an existing VM cluster, scaling placements that involve changing the resources allocated for an established VM cluster, and shuffling placements that involve adjusting previously-established placements of one or more VM clusters within the infrastructure.

For hierarchical infrastructures with constraints that restrict VM cluster placement to nodes in a single unit within the hierarchy (e.g., within a set of tightly-interconnected computing devices), selection of multiple lower-level optimal placements is performed, and then are compared based on the determined optimization criteria metrics to identify a higher-level optimal placement. Thus, the placement model is scalable to very large and complex infrastructures with minimal expenditure of resources to identify higher-level optimality of placement decisions.

Using the placement model described herein to identify and implement optimal placement of VM clusters allows for effective and efficient maintenance of VM clusters placed on an infrastructure with heterogeneous hardware. Using the placement model further allows for optimal utilization of hardware resources in light of any specialized requirements of applications being implemented by the VM clusters. When the hardware of a computing device is fully-utilized, the throughput of the computing system is maximized, allowing for more work to be done on the same hardware (as opposed to work performed based on a less-optimal utilization of the hardware). Furthermore, accommodations for planned/unplanned failure events may be built into the constraints and/or optimization metrics, resulting in VM cluster placement that provides the least impact to functionality when the failure events occur.

### 2. Example Computing System

VM cluster placement involves identifying one or more compute nodes, within a target infrastructure, on which to provision one or more VMs of the target VM cluster. The compute nodes of the target infrastructure may be configured in any way. According to various embodiments, the compute nodes of a target infrastructure are arranged as multiple sets of tightly-interconnected computing devices, which are referred to herein as “computing fabrics” (or more simply “fabrics”) where each computing fabric comprises a set of tightly-interconnected computing devices. Such an infrastructure is generally organized hierarchically, where computing fabrics are arranged into one or more higher-level groupings such as failure domains and/or availability domains.

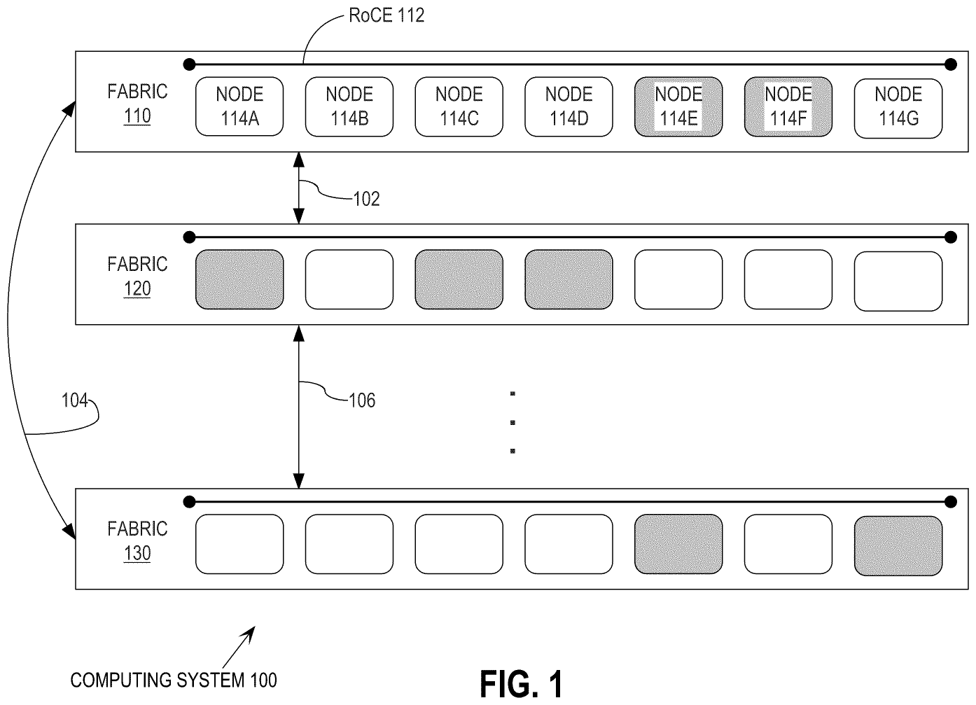

FIG. 1 depicts an example target infrastructure, i.e., computing system 100, comprising a plurality of computing devices (including compute nodes, storage nodes, etc.) arranged as fabrics 110, 120, and 130. Though not depicted in FIG. 1, computing devices of the fabrics may further be arranged in racks. Computing system 100 may include any number of fabrics.

The network connections among the nodes of a fabric allows a high level of interconnection and trust among the nodes. According to various embodiments, a fabric comprises computing devices that are interconnected using RDMA over Converged Ethernet (RoCE) connections, such as RoCE 112 that represents RoCE connections between nodes 114A-G of example fabric 110. A RoCE connection is configured to allow remote direct memory access (RDMA) requests among the compute nodes of a fabric using the RoCE network protocol. The fabrics of computing system 100 are interconnected by network connections 102, 104, and 106, which may be any type of network connection (e.g., ethernet connections). Generally, the fabrics of a target infrastructure are not tightly interconnected, as with the nodes within a fabric. Each fabric may have a distinct power source from the other fabrics within the system and/or may also have a distinct network by which users, originating from outside the system, may access the compute nodes of the fabric. In example computing system 100, various of the nodes are shaded to indicate that they are storage nodes, such as nodes 114E and 114F. Other types of nodes may also be present within a target infrastructure.

Computing system 100 is used herein as example hardware on which VM cluster placement techniques may be implemented. However, the described techniques for VM cluster placement are not limited to a computing system that has the shape identified in FIG. 1, and may be used for any configuration of hardware infrastructure.

Each compute node of system 100 is a computing device configured to run software. As a hardware infrastructure, such as computing system 100, is maintained over time, the hardware of the compute nodes becomes heterogeneous (if the hardware was not heterogeneous to begin with). Specifically, some nodes may be upgraded with newer or additional central processing units (CPUs) or graphic processing units (GPUs), or may be configured with more memory or storage, or with newer/different kinds of memory or storage. There may not be resources or the need to perform the same upgrades to all nodes of the infrastructure. Techniques described herein account for heterogeneous hardware among the nodes of a target infrastructure.

### 3. Virtual Machines

A virtual machine is a containment mechanism that is configured to perform computing tasks on a host compute node, which may or may not require accessing data stored remotely from the host compute node (e.g., on a storage node). A virtual machine is run by hypervisor software on the host node. Because a virtual machine includes its own operating system, the computing tasks performed by the virtual machine do not require intervention of the host operating system. Any number of virtual machines may be run by a given host compute node, where virtual machines running on the same host node run in isolation from each other. Because of the isolation and flexibility afforded by virtual machines, cloud computing infrastructures generally employ virtual machines to implement customer applications.

Virtual machine clustering uses multiple virtual machines, e.g., running on different compute nodes, to jointly perform the computing tasks. The VMs of a given VM cluster communicate, e.g., using a private connection established via the network links between host nodes hosting the VMs of the cluster, to ensure coordination of application execution. For example, a VM cluster running within a given fabric implements a multi-node database system where each VM of the cluster runs one or more database server instances, all of which access and manage database data that is stored on a storage node in the same fabric.

Using VM clusters, as opposed to single virtual machines, to implement an application can provide redundancy for application availability. In other words, if a particular

VM of a VM cluster fails (e.g., because the compute node hosting the particular VM fails, or the software supporting the particular VM fails, etc.), the other VMs of the VM cluster may be configured to perform the tasks of the failed VM.

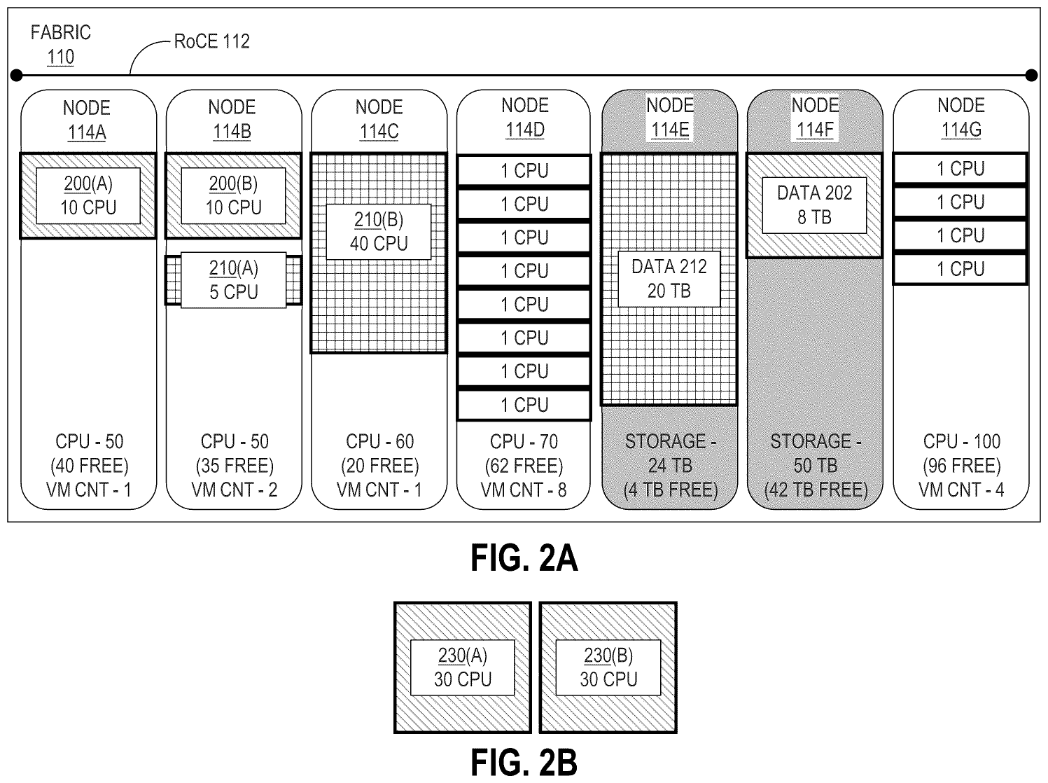

According to various embodiments, implementing VMs for a VM cluster on compute nodes from the same fabric allows for efficient communication between the VMs, which increases the efficiency of the VM cluster. The nodes hosting VMs for a VM cluster may be on the same rack and/or on different racks within the fabric. To illustrate, FIG. 2A depicts nodes 114A-G of fabric 110. In this example, compute node 114A has 50 CPUs, compute node 114B has 50 CPUs, compute node 114C has 60 CPUs, compute node 114D has 70 CPUs, storage node 114E has 24 terabytes (TB) of storage capacity, storage node 114F has 50 TB of storage capacity, and compute node 114G has 100 CPUs. Furthermore, fabric 110 hosts example VM clusters 200 and 210, where example VM cluster 200 comprises a VM 200(A) running on node 114A and a VM 200(B) running on node 114B, and example VM cluster 210 comprises a VM 210(A) running on node 114B and a VM 210(B) running on node 114C. Nodes 114D-114G also host various VMs and store data as indicated in FIG. 2. Thus, the example tenancy and CPU resources for the nodes of fabric 110 in FIG. 2A are as follows:
Compute node 114A hosts one VM, and has 50 total CPUs with 40 unallocated CPUs;
Compute node 114B hosts two VMs, and has 50 total CPUs with 35 unallocated CPUs;
Compute node 114C hosts one VM, and has 60 total CPUs with 20 unallocated CPUs;
Compute node 114D hosts eight VMs, and has 70 total CPUs with 62 unallocated CPUs;
Storage node 114E stores data 212 for VM cluster 210, and has a total storage capacity of 24 TB with 4 TB free;
Storage node 114F stores data 202 for VM cluster 200, and has a total storage capacity of 50 TB with 42 TB free; and
Compute node 114G hosts four VM, and has 100 total CPUs with 96 unallocated CPUs.
   CPU resource utilization is called out in connection with FIG. 2A to facilitate example metric calculations below.

### 4. Virtual Machine Cluster Placement Model

Optimal VM cluster placement may be influenced by a variety of factors, including the shape of the target infrastructure, requirements of the customer, optimization criteria for the target infrastructure, and requirements imposed by applications being implemented by the VM cluster being placed. For example, placement of VM clusters that implement database provisioning and execution may be subject to database-specific requirements such as resource requirements, scalability requirements, failover constraints for the VMs of the cluster, etc. According to various embodiments, techniques described herein are configured to provide optimal placement for database-specialized VM clusters that accounts for the database-specific needs of these VM clusters.

To identify an optimal placement for a given VM cluster within the nodes of a target infrastructure, potential combinations of host nodes for a VM cluster placement are selected based on applicable constraints on host nodes for the cluster. Further, applicable optimization criteria for the VM cluster and/or for the target infrastructure are formally defined and modeled in a placement model for automatic performance by a computing device. Application of this placement model to the various potential combinations of host nodes for the VM cluster results in one or more optimization criteria metrics that may be directly compared so that alternate potential host node combinations may be ranked based on the determined optimization criteria metrics. The highest-ranked node combination is identified as the optimal VM cluster placement.

In addition to optimal initial placement of a new VM cluster, the placement model is configured to be used to identify incremental placements that involve adding one or more VMs to an existing VM cluster, scaling placements that involve changing the resources allocated for an established VM cluster, and shuffling placements that involve adjusting previously-established placements of one or more VM clusters within the infrastructure.

By determining optimal VM cluster placement using both placement constraints and optimization criteria, the placement of VM clusters within the computing system properly distributes VMs across the computing system, increases the chance of utilizing the resources effectively, reduces the requirement for shifting VM clusters to improve overall computing system utilization, while ensuring that the VM cluster meets the needs of the customer.

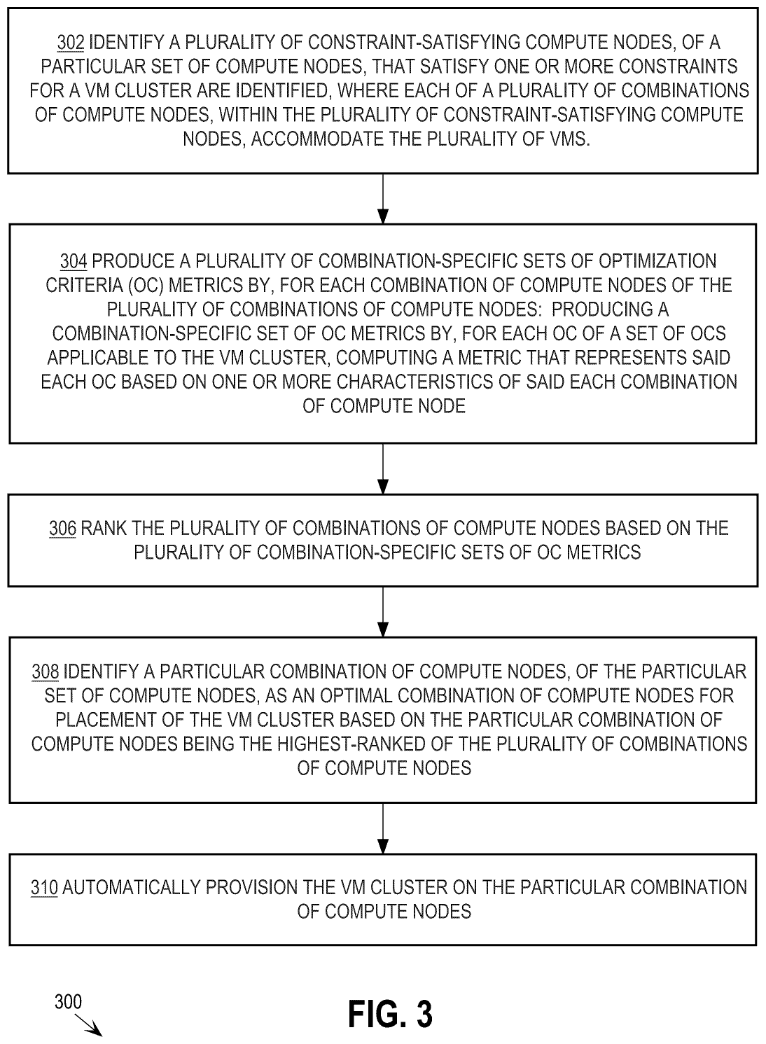

To illustrate identifying an optimal placement for a VM cluster, computing system 100 receives a request to place a new VM cluster depicted by cluster 230 of FIG. 2B. The request indicates that the new VM cluster 230 should have two VMs that implement a database application, where the cluster requires 10 TB of space on a storage node in the fabric and thirty CPUs for each VM of the cluster. A VM cluster to be placed may have any cardinality. According to various embodiments, in response to receiving the request, computing system 100 automatically identifies an optimal placement for VM cluster 230 based on constraints and optimization criteria that are applicable to the VM cluster placement, according to the steps of flowchart 300 of FIG. 3. VM cluster 230 is automatically provisioned within the target infrastructure based on the automatically-identified optimal placement. Both constraints and OC metrics may be configured to account for characteristics of the nodes in the infrastructure, and as such, allows the placement model to accommodate heterogeneous hardware.

### 4.1. Constraints

Generation of optimization criteria metrics for placement of a particular VM cluster is restricted to those combinations of compute nodes in the target infrastructure that satisfy one or more constraints that are applicable to the VM cluster. Constraints may be configured to promote proper functionality of the VM cluster within a hierarchy of resources in the infrastructure, or to satisfy customer requirements, requirements of the application to be run by the VM cluster, and/or requirements of applications running on the nodes of the target infrastructure, etc. Thus, a constraint identifies a condition of a compute node, or combination of compute nodes, that disqualifies the node(s) from hosting the VM cluster.

For example, a constraint indicates one of the following:
host nodes have a minimum amount of a given resource (such as CPUs, memory, local storage, network bandwidth, etc.) that is unallocated and that is able to be allocated (i.e., not reserved for administration use);
host nodes have one or more characteristics identified by the customer, e.g., one or more characteristics that are similar to characteristics of a compute node that hosts another VM for the target cluster, or particular hardware, firmware, or software, etc.;
host compute nodes may not span multiple fabrics (to facilitate fast communication among the VMs of the cluster);
one or more available resources of the node must include a particular amount of reserve that remains unallocated after VM provisioning, which may be used for node management, scaling, failover, and/or hypervisor purposes;
VMs in the same cluster should not be placed in the same host compute node;
a node must be able to accommodate a VM of the cluster according to one or more non-uniform memory access (NUMA) rules applicable to the VM, such as being allocated resources that are evenly affined across multiple NUMA sockets in the node or being allocated resources that are affined to a single NUMA socket (depending on the amount of the resource to be allocated to the VM);
resources (e.g., storage) available to the host nodes (e.g., on storage nodes of the same fabric) is sufficient for the needs of an application being implemented by the VM cluster;
less than a maximum number of VMs are currently running on the host node (e.g., which is an application-specific constraint for database-specific VM clusters);
the host nodes should be from a particular set of one or more compute nodes that is associated with a particular attribute, such as from a set of nodes that are dedicated to the customer;
consideration of maintenance domain of the host nodes; etc.

A constraint that is applicable to a VM cluster may be a default constraint maintained by computing system 100, may be a constraint maintained by computing system 100 that is associated with an attribute of the VM cluster to be placed, or may be identified in the request to place the VM cluster, etc. Accordingly, constraints may be determined to be applicable to a given VM cluster placement based on configuration information that maps constraint definitions to attributes of VM cluster placements, such as a customer for the placement, an application being implemented by the VM cluster, etc. In this case, any constraint that is mapped to an attribute of the target VM cluster is applicable to placement of the target VM cluster.

At step 302 of flowchart 300, a plurality of constraint-satisfying compute nodes, of a particular set of compute nodes, that satisfy one or more constraints for a VM cluster are identified, where each of a plurality of combinations of compute nodes, within the plurality of constraint-satisfying compute nodes, accommodate the plurality of VMs. For example, computing system 100 identifies five constraints that are applicable to the placement of example VM cluster 230: (1) a default constraint that indicates that combinations of host compute nodes may not span multiple fabrics; (2) a default constraint that indicates that VMs in the same cluster should not be placed in the same host compute node; (3) a constraint associated with the database application type (that will be run by VM cluster 230) that no more than eight VMs may be run by a host compute node; (4) a constraint from the placement request that each of the host compute nodes should each have at least thirty unallocated CPUs; and (5) a constraint from the placement request that a storage node in the fabric of the host nodes must have at least 10 free TB to allocate for the database application.

At the time of receiving the example request to place VM cluster 230, fabric 110 is as depicted in FIG. 2A. Accordingly, computing system 100 identifies a set of compute nodes, of fabric 110, that satisfy the constraints that are applicable to the placement of VM cluster 230. To illustrate, host nodes may be identified from fabric 110 since at least one storage node (i.e., storage node 114F) has at least 10 free TB to allocate for VM cluster 230. Computing system 100 determines that compute nodes 114A, 114B, 114C, and 114G all have less than the maximum number of eight VMs being hosted on the respective nodes, and compute nodes 114A, 114B, and 114G each have at least thirty available CPUs. Thus, computing system identifies compute nodes 114A, 114B, and 114G as the set of compute nodes from fabric 110 that satisfy the constraints for VM cluster 230.

Multiple combinations of compute nodes, from the identified the plurality of constraint-satisfying compute nodes (compute nodes 114A, 114B, and 114G) in fabric 110, accommodate the VMs of the requested VM cluster 230. Specifically, each of the following combinations of compute nodes are candidates for hosting the requested VM cluster 230: (a) compute nodes 114A and 114B, referred to as node combination A-B; (b) compute nodes 114B and 114G, referred to as node combination B-G; and (c) compute nodes 114A and 114G, referred to as node combination A-G.

### 4.2. Optimization Criteria

After identifying the combinations of compute nodes that satisfy the constraints that are applicable to the target VM cluster, optimization criteria (OC) metrics—for OCs that are applicable to the target VM cluster—are generated for the identified combinations of compute nodes. According to various embodiments, OCs represent one or more of goals for the optimal resource usage and execution of multi-tenant VM clusters, such as:
even distribution of one or more types of resources (such as CPUs, local storage, memory, network bandwidth, etc.) across the nodes within low-level groups (e.g., fabrics) of the target infrastructure;
even distribution of one or more types of resources across higher-level groups (e.g., failure domains) of the target infrastructure; and/or
optimized utilization of resources (reduction of resource wastage) within each node of the target infrastructure given software and/or NUMA limitations, such as based on a maximum number of VMs that may be placed on a single compute node, or based on distribution of VMs that use resources that are affined with the NUMA sockets of the node;
aiding ingestion of new hardware and phasing-out of outdated hardware over time; etc.

One factor in placing a VM cluster is resource consumption in light of any VMs already placed on the candidate host nodes. This factor involves one or more resources that are used by VMs of the cluster, including one or more of: OCPU (CPU cores, NUMA bound); memory (NUMA bound); local storage (locally attached); network capacity; shared storage (e.g., on a storage node in the same fabric); etc.

The placement model models optimization criteria as mathematically-derived metrics, which allows encoding of the importance of the various VM cluster goals and/or infrastructure goals to different customers or in different situations. OC metrics are generated for a VM cluster placement based on hypothetical placements of the VM cluster on the potential combinations of compute nodes that satisfy the applicable constraints. A hypothetical placement of a VM cluster on a target combination of nodes assumes placement of the VM cluster on the combination of compute nodes and metrics are calculated for the target combination of nodes as if the VM cluster were placed on the combination of nodes. The OC metrics resulting from the hypothetical placements are directly compared to rank the potential host node combinations using the metrics. The highest-ranked node combination is identified as the “optimal” VM cluster placement.

An OC that is applicable to a VM cluster may be a default OC maintained by computing system 100, may be an OC maintained by computing system 100 that is associated with an attribute of the VM cluster to be placed, or may be identified in the request to place the VM cluster, etc. Each attribute value (such as each customer, application type, etc.) may be associated with a different model/formula for generating metrics for particular optimization criteria, which allows the criteria metric generation to be customized to each VM cluster placement.

Returning to a discussion of flowchart 300 of FIG. 3, at step 304, a plurality of combination-specific sets of OC metrics are produced by, for each combination of compute nodes of the plurality of combinations of compute nodes: producing a combination-specific set of OC metrics by, for each OC of a set of OCs applicable to the VM cluster, computing a metric that represents said each OC based on one or more characteristics of said each combination of compute nodes. For example, using hypothetical placements of VM cluster 230 on each of node combinations A-B, B-G, and A-G, computing system 100 produces a combination-specific set of OC metrics that comprises a metric for each OC that is applicable to VM cluster 230. Non-limiting illustrative computations of example OCs are provided below.

### 4.2.1. Optimization Criterion: Resource Distribution Among Compute Nodes Within a Fabric

To further illustrate, an OC of even distribution of allocated resources across compute nodes within a fabric (“interFabric_density_dev”) is applicable to VM cluster 230. According to an embodiment, interFabric_density is calculated based on the density of a given resource within nodes of a fabric. Because different computing devices within a fabric may have different amounts of target resources, load balancing does not entail assigning an equal amount of processing to each virtual machine. Instead, load balancing entails distributing VMs within the fabric in proportion to the respective resource capacity of each node in the set. Such proportional load is referred to herein as density. Low variance of resource density across all compute nodes of a fabric indicates that the VMs allocated within the fabric are evenly distributed, without overloading or underutilizing any given node.

Application of interFabric_density increases the chance of placing more VMs within the fabrics of system 100 and reduces resource wastage. According to various embodiments, for each potential combination of host nodes representing a hypothetical placement for VM cluster 230, system 100 generates an interFabric_density metric for each evaluated resource (e.g., CPU (“cpu_interFabric_density”), memory (“mem_interFabric_density”), local storage (“sto_interFabric_density”), and/or network capacity (“net_interFabric_density”)). Computing system 100 generates the OC metric for a target resource (“<res>_interFabric_density”) for a given hypothetical placement of VM cluster 230 on a particular combination of nodes within a given fabric by calculated by a density value for the target resource for each compute node in the fabric (assuming placement of the VM cluster on the target combination of compute nodes), and then identifying the standard deviation of the density values of the fabric nodes.

Specifically, for a given combination of potential host compute nodes, the following Formula 1 is used to calculate the resource density for a node:

$$< res > \_interFabric \_densi ty [ node ] combo = \frac{\sum < res > [ node , vm ]}{total\_ < re s > [ node ]} \qquad Formula 1$$

Formula 1 calculates the density of a target resource by summing the resource utilization of each VM on the node (including any hypothetically-placed VM), and dividing the result by the total amount of the resource for the node. Such a density formula calculates a density of 50% for a node that has allocated half of the target resource to VMs on the node, and a density of 100% for a node that has allocated all of the target resource to VMs on the node.

For each combination of compute nodes, the standard deviation of the memory density for all of the nodes of the fabric is computed. The combination of compute nodes for placement of the VM cluster that results in the most even allocation of the target resource is the combination that results in the lowest standard deviation across compute nodes of the fabric. This type of measuring of resource density deviation accounts for heterogeneous resources in the computing system.

To illustrate, computing system 100 computes cpu_interFabric_density[node]_{combo} values of fabric nodes for hypothetical placements of VM cluster 230 on each of node combinations A-B, B-G, and A-G. For each host node combination, computing system 100 then computes a cpu_interFabric_density_dev[combo] based on the cpu_interFabric_density[node]_{combo} values, determined for all nodes in the fabric.

To illustrate for compute node combination A-B, hypothetical placement of one of the VMs of VM cluster 230 on node 114A would result in 40 allocated CPUs out of the 50 CPUs in the compute node, which would be a cpu_interFabric_density[114]_{A-B} of 40/50=0.8. Further, hypothetical placement of the other VM of VM cluster 230 on node 114B would result in 45 allocated CPUs out of the 50 CPUs in the compute node, which would be a cpu_interFabric_density[114B]_{A-B} of 45/50=0.9. The cpu_interFabric_density[node]_{A-B} values for the other compute nodes in fabric 110 are: cpu_interFabric_density[114C]_{A-B}=0.67; cpu_interFabric_density[114D]_{A-B}=0.11; and cpu_interFabric_density[114G]_{A-B}=0.04. Thus, the cpu_interFabric_density_dev[A-B] for fabric 110, i.e., with hypothetical placement of VM cluster 230 on compute nodes 114A and 114B, is 0.36.

Based on hypothetical placement of VM cluster 230 on combination B-G, the cpu_interFabric_density[node]_{B-G} values for the compute nodes in fabric 110 are: cpu_interFabric_density[114A]_{B-G}=0.2; cpu_interFabric_density[114B]_{B-G}=0.9; cpu_interFabric_density[114C]_{B-G}=0.67; cpu_interFabric_density[114D]_{B-G}=0.11; and cpu_interFabric_density[114G]_{B-G}=0.34. Thus, the cpu_interFabric_density_dev[B-G] for fabric 110, i.e., with hypothetical placement of VM cluster 230 on compute nodes 114B and 114G, is 0.30.

Based on hypothetical placement of VM cluster 230 on combination A-G, the CPU density[node]_{A-G} values for the compute nodes in fabric 110 are: cpu_interFabric_density[114A]_{A-G}=0.8; cpu_interFabric_density[114B]_{A-G}=0.3; cpu_interFabric_density[114C]_{A-G}=0.67; cpu_interFabric_density[114D]_{A-G}=0.11; and cpu_interFabric_density[114G]_{A-G}=0.34. Thus, the cpu_interFabric_density_dev[A-G] for fabric 110, i.e., with hypothetical placement of VM cluster 230 on compute nodes 114A and 114G, is 0.25.

### 4.2.2. Optimization Criterion: Resource Distribution Across Fabrics

As another example, an OC of even distribution of allocated resources of compute nodes across fabrics (“intraFabric_density_avg”) is applicable to VM cluster 230. Application of intraFabric_density spreads the VM load across available fabrics, which ensures that all fabrics are utilized for VM clusters without overloading any one or more fabrics and underutilizing others. According to various embodiments, for each combination of nodes representing a hypothetical placement for VM cluster 230, system 100 generates an intraFabric_density metric for each evaluated resource (e.g., CPU (“cpu_intraFabric_density”), memory (“mem_intraFabric_density”), local storage (“sto_intraFabric_density”), and network capacity (“net_intraFabric_density”)). According to an embodiment, intraFabric_density metrics are generated in the manner described above for interFabric_density metrics.

According to various embodiments, a cpu_intraFabric_density_avg[combo] value is generated for each potential combination of host compute nodes for a VM cluster placement by averaging the CPU density generated for all nodes in all fabrics of system 100. Specifically, the density of the target resource is determined for each node of each fabric (with the hypothetical placement) and the average density is computed for all nodes in the multi-fabric group. In the example given below, the average density is computed for each fabric, and then the average density determined from the fabric-level average values.

For example, the cpu_intraFabric_density_[node]_{A-B} values for the compute nodes in fabric 110 are: cpu_intraFabric_density_[114A]_{A-B} of 40/50=0.8; cpu_intraFabric_density[114B]_{A-B} of 45/50=0.9; cpu_intraFabric_density_[114C]_{A-B}=0.67; cpu_intraFabric_density[114D]_{A-B}=0.11; and cpu_intraFabric_density_[114G]_{A-B}=0.04. The average CPU density for combination A-B, for the nodes of fabric 110, is 0.50.

In this example, system 100 includes two other fabrics 120 and 130. The average CPU density for the nodes of fabric 120 without placing VM cluster 230 on this fabric is 0.42, and the average CPU density for the nodes of fabric 130 without placing VM cluster 230 on the fabric is 0.55. Thus, the cpu_intraFabric_density_avg[A-B], which is a multi-fabric metric, with hypothetical placement of VM cluster 230 on compute nodes 114A and 114B of fabric 110 is the average of the average CPU densities of the various fabrics, i.e., 0.49.

Calculated in a similar manner, the average CPU density for combination B-G, for the nodes of fabric 110, is 0.44. Using the same average CPU density values for fabrics 120 and 130 indicated above, the cpu_intraFabric_density_avg[B-G] is 0.47. Further, the average CPU density for combination A-G, for the nodes of fabric 110, is 0.44. Thus, cpu_intraFabric_density_avg[A-G] is also 0.47.

### 4.2.3. Optimization Criterion: Reduce Unused Resources Based on a Virtual Machine Maximum Limit

As another example, an OC (called “VM_opt_dev”) represents whether a VM should be placed on a compute node in light of a maximum number of VMs (VM_max) that may be placed on a single compute node to reduce unused resources. A VM_max may be a requirement of an application being run by the VM cluster being placed, or of one or more applications being run within the combination of potential host compute nodes. In some cases, exceeding a particular number of VMs running on a given compute node reduces the efficiency of the VMs on the node. For example, each VM may be associated with a fixed cost of VM maintenance, and placing more than a maximum number of VMs would increase the VM maintenance cost beyond a tolerable level and reduce the resources available to the VMs.

The VM_opt metric accounts for the fact that, in light of a VM_max for compute nodes, placing too many small VMs on a single compute node leads to resource wastage. For example, if VM_max=8 and a particular compute node has 32 CPUs, placing 8 small VMs (using two CPUs each) on the particular compute node would prevent placement of VMs that could use the remaining unallocated 16 CPUs on the compute node. In light of a VM_max requirement for compute nodes of computing system 100, the best placement scenario for a given node with X amount of a resource is one or more VMs, each using at least X/VM_Max of the resource, that in total utilize all X of the resource. The worst placement scenario for a given node is the maximum number of VMs running on the compute node, each requiring a minimal amount of a resource.

Thus, the VM_opt metric compares the average amount of a resource that is allocated to the VMs on a node including any hypothetical placements (<res>_VM_curr_avg[node]_{combo}) to an “ideal” average amount of the resource that would result from the VM_max number of VMs running on the node and using all of the resource (<res>_VM_opt_avg[node]). The VM_opt metric is calculated for one or more target resources (“<res>”), such as CPU, memory, local storage, and/or network bandwidth. The VM_opt metric ranges from 0-100 with 100 being the worst distribution of the node resources. The following Formulas 2 and 3 illustrate calculation of VM_curr_avg and VM_opt_avg for each node, which are used to determine the VM_opt_dev metrics for the nodes:

<res >_VM_opt_avg[node]=total_<res>[node]/VM_max Formula 2

<res>_VM_curr_avg_[node]combo=VM_<res>_[node]combo/VM_cnt[node]combo Formula 3

In the above formulas, total_<res>[node] represents the total amount of the target resource on the node, VM_<res>[node]_{combo} represents the amount of the target resource that is being utilized by the VMs that are present on the node including any hypothetical placement, and VM_cnt[node]_{combo} represents the number of VMs on the node including any hypothetical placement.

To illustrate, with a VM_max of 8, the cpu_VM_opt_avg[node] for each compute node of fabric 110 with the arrangement of CPU resources displayed in FIG. 2A, is as follows based on Formula 2:
cpu_VM_opt_avg[A]=50/8=6.25
cpu_VM_opt_avg[B]=50/8=6.25
cpu_VM_opt_avg[C]=60/8=7.5
cpu_VM_opt_avg[D]=70/8=8.75
cpu_VM_opt_avg[G]=100/8=12.5

With a hypothetical placement of VM cluster 230 on A-B, the cpu_VM_curr_avg[node]_{combo} for each compute node of fabric 110 is as follows based on Formula 3 (note that a comparison of cpu_VM_curr_avg[node]_{combo} and cpu_VM_opt_avg[node] is provided, which is pertinent to application of Formulas 4 and 5 demonstrated below):
cpu_VM_curr_avg[A]_{A-B}=40/2=20 (greater than cpu_VM_opt_avg[A])
cpu_VM_curr_avg[B]_{A-B}=45/3=15 (greater than cpu_VM_opt_avg[B])
cpu_VM_curr_avg[C]_{A-B}=40/1=40 (greater than cpu_VM_opt_avg[C])
cpu_VM_curr_avg[D]_{A-B}=8/8=1 (less than cpu_VM_opt_avg[D])
cpu_VM_curr_avg[G]_{A-B}=4/4=1 (less than cpu_VM_opt_avg[G])
   With a hypothetical placement of VM cluster 230 on B-G, the cpu_VM_curr_avg[node]_{combo} for each compute node of fabric 110 is as follows based on Formula 3:
cpu_VM_curr_avg[A]_{B-G}=10/1=10 (greater than cpu_VM_opt_avg[A])
cpu_VM_curr_avg[B]_{B-G}=45/3=15 (greater than cpu_VM_opt_avg[B])
cpu_VM_curr_avg[C]_{B-G}=40/1=40 (greater than cpu_VM_opt_avg[C])
cpu_VM_curr_avg[D]_{B-G}=8/8=1 (less than cpu_VM_opt_avg[D])
cpu_VM_curr_avg[G]_{B-G}=34/5=6.8 (less than cpu_VM_opt_avg[G])
   With a hypothetical placement of VM cluster 230 on A-G, the cpu_VM_curr_avg[node]_{combo} for each compute node of fabric 110 is as follows based on Formula 3:
cpu_VM_curr_avg[A]_{A-G=}40/2=20 (greater than cpu_VM_opt_avg[A])
cpu_VM_curr_avg[B]_{A-G=}15/3=5 (less than cpu_VM_opt_avg[B])
cpu_VM_curr_avg[C]_{A-G=}40/1=40 (greater than cpu_VM_opt_avg[C])
cpu_VM_curr_avg[D]_{A-G=}8/8=1 (less than cpu_VM_opt_avg[D])
cpu_VM_curr_avg[G]_{A-G=}34/5=6.8 (less than cpu_VM_opt_avg[G])

If <res>_VM_curr_avg[node]_{combo} is greater than <res>_VM_opt_avg[node], then the deviation of the resource density from the optimum density, for the node, (<res>_VM_opt_dev[node]_{combo}) is calculated according to Formula 4 below, else <res>_VM_opt_dev[node]_{combo} is calculated according to Formula 5 below.

$$< res > \_VM \_opt {\_d ev [ node ]}_{c o m b o} = 50 - 50 * ( \frac{\begin{matrix}< res > \_VM \_curr {\_a vg [ node ]}_{c o m b o} - \\ < res > \_VM \_opt \_a vg [ node ]\end{matrix}}{total\_ < re s > [ node ] - < r es > \_VM \_opt \_a vg [ node ]} ) \qquad Formula 4$$

$$< res > \_VM \_opt {\_d ev [ node ]}_{c o m b o} = 50 + 50 * ( \frac{\begin{matrix}< res > \_VM \_opt \_avg [ node ] - \\ < res > \_VM \_curr {\_avg [ node ]}_{c o m b o}\end{matrix}}{< r es > \_VM \_opt \_avg [ node ]} ) \qquad Formula 5$$

To illustrate, with a hypothetical placement of VM cluster 230 on A-B, the cpu_VM_opt_dev[node]_{combo} for each compute node of fabric 110 is as follows based on Formulas 4 or 5, as indicated (rounded to the nearest whole number):
Formula 4: cpu_VM_opt_dev[A]_{A-B}=50−50*((20−6.25)/(50−6.25))=34
Formula 4: cpu_VM_opt_dev[B]_{A-B}=50−50*((15−6.25)/(50−6.25))=40
Formula 4: cpu_VM_opt_dev[C]_{A-B}=50−50*((40−7.5)/(60−7.5))=19
Formula 5: cpu_VM_opt_dev[D]_{A-B}=50+50*((8.75−1)/8.75)=94
Formula 5: cpu_VM_opt_dev[G]_{A-B}=50+50*((12.5−1)/12.5)=96
   With a hypothetical placement of VM cluster 230 on B-G, the cpu_VM_opt_dev[node]_{combo} for each compute node of fabric 110 is as follows based on Formulas 4 or 5, as indicated:
Formula 4: cpu_VM_opt_dev[A]_{B-G}=50−50*((10−6.25)/(50−6.25))=46
Formula 4: cpu_VM_opt_dev[B]_{B-G}=50−50*((15−6.25)/(50−6.25))=40
Formula 4: cpu_VM_opt_dev[C]_{B-G}=50−50*((40−7.5)/(60−7.5))=19
Formula 5: cpu_VM_opt_dev[D]_{B-G}=50+50*((8.75−1)/8.75)=94
Formula 5: cpu_VM_opt_dev[G]_{B-G}=50+50*((12.5−6.8)/12.5)=73
   With a hypothetical placement of VM cluster 230 on A-G, the cpu_VM_opt_dev[node]_{combo} for each compute node of fabric 110 is as follows based on Formulas 4 or 5, as indicated:
Formula 4: cpu_VM_opt_dev[A]_{A-G}=50−50*((20−6.25)/(50−6.25))=34
Formula 5: cpu_VM_opt_dev[B]_{A-G}=50+50*((6.25−5)/6.25)=60
Formula 4: cpu_VM_opt_dev[C]_{A-G}=50−50*((40−7.5)/(60−7.5))=19
Formula 5: cpu_VM_opt_dev[D]_{A-G}=50+50*((8.75−1)/8.75)=94
Formula 5: cpu_VM_opt_dev[G]_{A-G}=50+50*((12.5−6.8)/12.5)=73

For each combination of host compute nodes on which VM cluster 230 may be placed, <res>_VM_opt_dev[combo] is calculated by taking the standard deviation of the <res>_VM_opt_dev[node]_{combo} for all of the nodes of the fabric with a hypothetical placement on the target host node combination. To illustrate, given the cpu_VM_opt_dev[node]_{combo} values calculated above:
cpu_VM_opt_dev[A-B]=32.10
cpu_VM_opt_dev[B-G]=26.25
cpu_VM_opt_dev[A-G]=26.84

### 4.2.4. Optimization Criterion: NUMA Balancing

Compute nodes can have two or more NUMA sockets to which resources of the compute nodes (such as CPUs, memory, and network devices) can be affined. The NUMA affinities of resources allocated to a VM can affect the efficiency of VM processing. For example, smaller VMs (e.g., VMs that utilize four CPUs or less) should be allocated CPUs that are affined to the same NUMA socket to reduce memory access latency. However, larger VMs (e.g., that utilize 16 or more 16 CPUs) should be allocated resources that are affined across the NUMA sockets as evenly as possible to increase performance efficiency. CPU resources for VMs that require between four and 16 CPUs may be split across NUMA sockets or affined to a single socket. It is possible for multiple smaller VMs to be placed within a single NUMA socket without fully utilizing the other NUMA socket on the node, which may result in persistent underutilization of the resources affined to the other NUMA socket.

Thus, as another example, an OC (called “NUMAdev_avg”) to minimize NUMA socket affinity imbalance is applicable to VM cluster 230. According to various embodiments, the NUMAdev metric is calculated with respect to one or more target resources, such as CPUs, memory, network, and/or local storage. Application of NUMAdev increases the probability of balancing resources, allocated to VMs, across the NUMA sockets in the compute nodes of system 100.

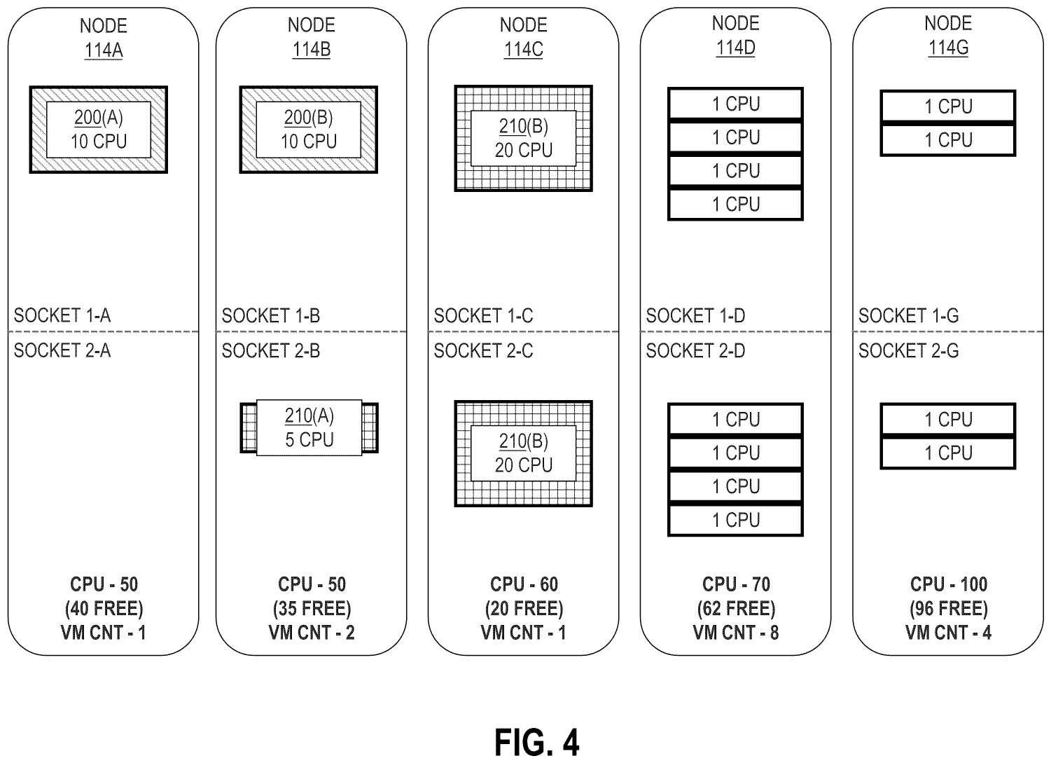

To illustrate, each of the compute nodes of fabric 110 have two NUMA sockets with CPUs affined evenly across the two NUMA sockets. In this example, if a VM requires 16 or more CPUs, the CPUs are evenly affined to the two NUMA sockets. If a VM requires less than 16 CPUs, the CPUs are affined to a single NUMA socket. FIG. 4 depicts the affinities of CPUs allocated to the VMs on compute nodes 114A, 114B, 114C, 114D, and 114G (shown in FIG. 2A) with regard to the two NUMA sockets for each of the nodes. As shown, VM 210(B), with 40 CPUs, has been allocated CPUs that are evenly affined across the two NUMA sockets in compute node 114C. The other VMs utilize less than 16 CPUs, and as such, have been allocated CPUs that are affined to a single socket, respectively.

For a given combination of potential host compute nodes, the following Formula 6 is used to calculate a ratio of the resources, affined to each socket of each node, that are being used to the resources affined to the socket in total (“<res>_numa_ratio[node, numa_socket]_{combo}”), as shown in the following Formula 6. The <res>_NUMAdev[node]_{combo} for each node is the standard deviation of <res>_numa_ratio[node, numa_socket]_{combo} for the sockets of the node.

$$< res > \_numa {\_ [ node , numa\_socket ]}_{c o m b o} = \frac{{numa\_usage [ node , numa\_socket ]}_{c o m b o}}{< r es > \_max [ node , numa\_socket ]} \qquad Formula 6$$

With a hypothetical placement of VM cluster 230 on A-B, and assuming even affinities of the CPUs for VMs 230(A) and 230(B) across the sockets of the target host nodes (i.e., 15 CPUs affined to each of sockets 1 and 2), the cpu_NUMAdev[node]_{combo} for each compute node of fabric 110 is as follows:
Node 114A
   cpu_numa_ratio[A,socket-1]_{A-B}=25/25=1.00
   cpu_numa_ratio[A,socket-2]_{A-B}=15/25=0.60
   cpu_NUMAdev[A]_{A-B}=0.2
Node 114B
   cpu_numa_ratio[B,socket-1]_{A-B}=25/25=1.00
   cpu_numa_ratio[B,socket-2]_{A-B}=20/25=0.80
   cpu_NUMAdev[B]_{A-B}=0.1
Node 114C
   cpu_numa_ratio[C,socket-1]_{A-B}=20/30=0.66
   cpu_numa_ratio[C,socket-2]_{A-B}=20/30=0.66
   cpu_NUMAdev[C]_{A-B}=0.0
Node 114D
   cpu_numa_ratio[D,socket-1]_{A-B}=4/35=0.11
   cpu_numa_ratio[D,socket-2]_{A-B}=4/35=0.11
   cpu_NUMAdev[D]_{A-B}=0.0
Node 114G
   cpu_numa_ratio[G,socket-1]_{A-B}=2/50=0.04
   cpu_numa_ratio[G,socket-2]_{A-B}=2/50=0.04
   cpu_NUMAdev[G]_{A-B}=0.0
      With a hypothetical placement of VM cluster 230 on B-G, the cpu_NUMAdev[node]_{combo} for each compute node of fabric 110 is as follows:
Node 114A
   cpu_numa_ratio[A,socket-1]_{B-G}=10/25=0.40
   cpu_numa_ratio[A,socket-2]_{B-G}=0/25=0.00
   cpu_NUMAdev[A]_{B-G}=0.2
Node 114B
   cpu_numa_ratio[B,socket-1]_{B-G}=25/25=1.00
   cpu_numa_ratio[B,socket-2]_{B-G}=20/25=0.80
   cpu_NUMAdev[B]_{B-G}=0.1
Node 114C
   cpu_numa_ratio[C,socket-1]_{B-G}=20/30=0.66
   cpu_numa_ratio[C,socket-2]_{B-G}=20/30=0.66
   cpu_NUMAdev[C]_{B-G}=0.0
Node 114D
   cpu_numa_ratio[D,socket-1]_{B-G}=4/35=0.11
   cpu_numa_ratio[D,socket-2]_{B-G}=4/35=0.11
   cpu_NUMAdev[D]_{B-G}=0.0
Node 114G
   cpu_numa_ratio[G,socket-1]_{B-G}=17/50=0.34
   cpu_numa_ratio[G,socket-2]_{B-G}=17/50=0.34
   cpu_NUMAdev[G]_{B-G}=0.0
      With a hypothetical placement of VM cluster 230 on A-G, the cpu_NUMAdev[node]_{combo} for each compute node of fabric 110 is as follows:
Node 114A
   cpu_numa_ratio[A,socket-1]_{A-G}=25/25=1.00
   cpu_numa_ratio[A,socket-2]_{A-G}=15/25=0.60
   cpu_NUMAdev[A]_{A-G}=0.2
Node 114B
   cpu_numa_ratio[B,socket-1]_{A-G}=10/25=0.40
   cpu_numa_ratio[B,socket-2]_{A-G}=5/25=0.20
   cpu_NUMAdev[B]_{A-G}=0.1
Node 114C
   cpu_numa_ratio[C,socket-1]_{A-G}=20/30=0.66
   cpu_numa_ratio[C,socket-2]_{A-G}=20/30=0.66
   cpu_NUMAdev[C]_{A-G}=0.0
Node 114D
   cpu_numa_ratio[D,socket-1]_{A-G}=4/35=0.11
   cpu_numa_ratio[D,socket-2]_{A-G}=4/35=0.11
   cpu_NUMAdev[D]_{A-G}=0.0
Node 114G
   cpu_numa_ratio[G,socket-1]_{A-G}=17/50=0.34
   cpu_numa_ratio[G,socket-2]_{A-G}=17/50=0.34
   cpu_NUMAdev[G]_{A-G}=0.0

For each combination of host compute nodes on which VM cluster 230 may be placed, <res>_NUMAdev_avg[combo] is calculated by taking the average of the <res>_NUMAdev[node]_{combo} values for all of the nodes of the fabric with a hypothetical placement on the target host node combination. To illustrate, given the cpu_NUMAdev[node]_{combo} values calculated above (which were the same for all combinations), the cpu_NUMAdev_avg[combo] values for A-B, B-G, and A-G are all 0.14.

### 4.2.5. Optimization Criterion: Resource Wastage Index

As yet another example, an OC of reducing resource wastage (“wastage_index_avg”) is applicable to VM cluster 230. As indicated above, application of a VM_max limit or NUMA socket affinity-based allocation of resources may result in resource wastage, where some of the resources of a node are unable to be allocated for VM utilization. According to various embodiments, the wastage_index metric is calculated with respect to one or more target resources, such as CPUs, memory, network, and/or local storage. Application of wastage_index reduces underutilized resources in the compute nodes of system 100. In this case, a higher wastage_index metric indicates a higher level of resource wastage.

Specifically, for a given combination of potential host compute nodes, if (after hypothetical allocation of the target VM cluster on the target combination of nodes) the number of VMs on a node is less than VM_max, <res>_wastage_index[node]_{combo} for the node is 0. Otherwise, the following Formula 7 is used to calculate the <res>_wastage_index[node]_{combo}:

<res>_wastage_index[node]_{combo}=1−(<res>_curr[node]_{combo}/total_<res>[node]) Formula 7

To illustrate, for all potential combinations of host compute nodes for VM cluster 230, the cpu_wastage_index for all compute nodes (except node 114D) is 0 since none of these nodes will reach the VM_max of eight with any hypothetical placement of the target VM cluster. Node 114D is already at the maximum of eight VMs, and cpu_wastage_index[D], for all combinations of host compute nodes, is 1−8/70=0.89. According to various embodiments, the <res>_wastage_index_avg[combo] value for a given host node combination is the average of the <res>_wastage_index[node]_{combo} values calculated for the nodes of the fabric.

### 4.3. Selecting an Optimal Combination of Host Nodes for VM Cluster Placement

Returning to a discussion of flowchart 300 of FIG. 3, at step 306 the plurality of combinations of compute nodes are ranked based on the plurality of combination-specific sets of OC metrics. Also, at step 308, a particular combination of compute nodes, of the particular set of compute nodes, is identified as an optimal combination of compute nodes for placement of the VM cluster based on the particular combination of compute nodes being the highest-ranked of the plurality of combinations of compute nodes. For example, after generating a set of OC metrics for each of the potential combinations of compute nodes that may host VM cluster 230, computing system 100 automatically ranks the combinations of compute nodes based on the associated sets of OC metrics and identifies the “optimal” combination of compute nodes for hosting VM cluster 230 to be the highest-ranking combination of compute nodes.

The sets of OC metrics are evaluated to determine the rankings of the associated compute node combinations. Each OC metric type is associated with a comparison objective that allows for identification of a highest-ranking metric from multiple metrics of that type. To illustrate, for each combination of compute nodes identified for VM cluster 230, computing system 100 generates the OC metrics, having the indicated comparison objectives, in the following Table 1:

TABLE 1
OC Metrics and Comparison Objectives

| OPTIMIZATION | | COMPARISON |
|---|---|---|
| CRITERION TYPE | OC METRIC | OBJECTIVE |
| Distribution | cpu_interFabric_ | Minimize |
| (within fabric) | density_dev | deviation for |
| | mem_interFabric_ | spread; or |
| | density_dev | Maximize |
| | sto_interFabric_ | deviation for |
| | density_dev | skew/pack |
| Distribution | cpu_intraFabric_ | Minimize |
| (across fabrics) | density_avg | average |
| | mem_intraFabric_ | for rows |
| | density_avg | |
| | sto_intraFabric_ | |
| | density_avg | |
| Reduce unused | cpu_VM_opt_dev | Minimize |
| resources | mem_VM_opt_dev | optimum |
| (based onVM | sto_VM_opt_dev | density |
| maximum limit) | | deviation |
| NUMA | cpu_NUMAdev_avg | Minimize the |
| balancing | mem_NUMAdev_avg | deviation of |
| | sto_NUMAdev_avg | internal deviation |
| | | of NUMA |
| | | resources |
| Resource wastage | cpu_wastage_index_avg | Minimize |
| index | mem_wastage_index_ | resource |
| | avg | wastage index |
| | sto_wastage_index_avg | |

To illustrate comparing a particular set of OC metrics (of a given type) using an associated comparison objective, the comparison objective associated with cpu_interFabric_density_dev is minimization of the deviation values. As indicated above, the cpu_interFabric_density_dev[A-B] for fabric 110 is 0.36, the cpu_interFabric_density_dev[B-G] for fabric 110 is 0.30, and the cpu_interFabric_density_dev[A-G] for fabric 110 is 0.25. Given the comparison objective of minimizing the deviation values calculated for cpu_interFabric_density_dev, combination A-G has the highest-ranking cpu_interFabric_density_dev metric.

OCs for a given VM cluster may be compatible or may be contradictory. Furthermore, ranking the compute node combinations with respect to the different metrics determined for the combinations may result in different rank ordering of the compute node combinations. As such, computing system 100 compares the combination-specific sets of OC metrics generated for the different combinations of host nodes using one of the following comparison schemes: weighted comparison, ordered comparison, or hybrid comparison, described in further detail below. Each comparison scheme identifies a methodology for using sets of metrics, comprising multiple OC metrics, to rank the combinations of compute nodes for a given VM cluster placement.

### 4.3.1. Weighted Comparison Scheme

According to an embodiment, computing system 100 compares the combination-specific sets of OC metrics using a weighted comparison scheme that produces a composite optimality score (COS) for each potential combination of host compute nodes for a VM cluster. COSs behave in ways that facilitate ranking the compute node combinations. For example, multiple COSs may be directly compared as numbers so that respective COSs of alternate combinations of host nodes may be ranked to select an “optimal” combination with a highest COS.

According to the weighted comparison scheme, each OC metric calculated for the potential placement combinations is associated with a weight value (e.g., a natural number) that may be provided by a user and/or derived from an order of importance of the OC metrics provided by a user. To illustrate deriving weights for OC metrics based on an ordering of importance, a user indicates that the order of importance of the OC metrics calculated for VM cluster 230 is the ordering indicated in Table 1 above. Accordingly, computing system 100 assigns weights that are proportional to the position of the OC metric within the ordered list, such as assigning cpu_interFabric_density_dev a weight of 1, assigning mem_interFabric_density_dev a weight of 14/15, assigning sto_interFabric_density_dev a weight of 13/15, and so on.

To provide a simple illustrative example, the following OC metrics are calculated for each of combinations A-B, B-G, and A-G: {cpu_interFabric_density_dev; cpu_intraFabric_density_avg; cpu_VM_opt_dev}. Accordingly, the OC metric sets for the potential combinations of host nodes for placement of VM cluster 230 within fabric 110 are as follows:
A-B: {0.36; 0.49; 32.10}
B-G: {0.30; 0.47; 26.25}
A-G: {0.25; 0.47; 26.84}

The various OC metrics are associated with different scales and potentially with both maximization and minimization comparison objectives. Prior to combining the metrics to produce a COS for each combination of host compute nodes, the metrics are normalized to ensure that all of the metrics are evenly weighted (prior to applying the user-directed weights). For example, linear normalization is applied to each of the OC metrics (M) for combinations A-B, B-G, and A-G, according to Formula 8 below:

$${M}_{norm} = \frac{M - {M}_{min}}{{M}_{max} - {M}_{min}} \qquad Formula 8$$

Thus, the normalized OC metric sets for the potential host combinations are:
A-B: {1.0; 1.0; 1.0}
B-G: {0.45; 0.0; 0.0}
A-G: {0.0; 0.0; 0.10}

All of these OC metrics have minimization-type comparison objectives (i.e., where lower metric values are better), though OC metrics are not limited to being associated with minimization-type comparison objectives. According to various embodiments, if the majority of OC metrics have minimization-type comparison objectives, then the reciprocal of the normalized value of any OC metric with a maximization-type comparison objective is taken prior to calculating the COS values to convert the maximization-type comparison objective to a minimization-type comparison objective for any such OC metrics (or vice versa).

In the above example, a user has identified weights for the OC metrics as follows, with higher weights identifying more important OC metrics: cpu_interFabric_density_dev: 0.9; cpu_intraFabric_density_avg: 0.7; and cpu_VM_opt_dev: 0.5. According to various embodiments, because the COS is based on a plurality of OC metrics with minimization-type comparison objectives, the weights are converted to reciprocal values to ensure that the higher weight values are weighted more heavily for the minimization comparison objective than lower weight values. Alternatively, the user may associate lower weights with the more important OC metrics.

Continuing with the example weights provided by a user, the COS for each combination is computed as follows: (1/0.9)*cpu_interFabric_density_dev[combo]ₙₒᵣₘ+(1/0.7)*cpu_intraFabric_density_avg[combo]ₙₒᵣₘ+(1/0.5)*cpu_VM_opt_dev[combo]ₙₒᵣₘ. Accordingly, the COSs for the potential combinations of host compute nodes for VM cluster 230 are as follows:
COS_{A-B}=(1/0.9)*1.0+(1/0.7)*1.0+(1/0.5)*1.0=4.54
COS_{B-G}=(1/0.9)*0.45+(1/0.7)*0.0+(1/0.5)*0.0=0.50
COS_{A-G}=(1/0.9)*0.0+(1/0.7)*0.0+(1/0.5)*0.1=0.20
   Using the minimization comparison objective, A-G is identified as the highest-ranked combination of host nodes for VM cluster 230.

In this example, the COS is generated by adding the weighted OC metrics. However, any mathematical operator/formula may be used to calculate a COS.

### 4.3.2. Ordered Comparison Scheme

According to an embodiment, computing system 100 compares the combination-specific sets of OC metrics as a sequence using an ordered comparison scheme. Specifically, using an ordered comparison scheme, the OC metrics are analyzed individually. Each OC metric is ranked by a user, and the ranking is used to determine the order of analysis of the metrics for purposes of identifying an optimal placement.

Continuing with the simple example involving the OC metrics cpu_interFabric_density_dev, cpu_intraFabric_density_avg, and cpu_VM_opt_dev above, the user identifies cpu_intraFabric_density_avg to be the most important metric, followed by cpu_VM_opt_dev and then cpu_interFabric_density_dev. Thus, computing system 100 first considers the cpu_intraFabric_density_avg, which identifies both B-G and A-G as equally-ranked. Thus, computing system 100 analyzes the cpu_VM_opt_dev values to determine which of B-G and A-G (the equally-ranked combinations based on the most important metric) should be considered the optimal combination for VM cluster 230. Because B-G has the lowest value for the cpu_VM_opt_dev metric, B-G is identified as the highest-ranked (“optimal”) placement for VM cluster 230 within fabric 110.

### 4.3.3. Hybrid Comparison Scheme

According to various embodiments, computing system 100 compares the combination-specific sets of OC metrics using a hybrid comparison scheme that employs a combination of generating one or more partial COSs from less than all OC metrics for potential combinations of host compute nodes for a given VM cluster and comparing multiple partial COSs or one or more partial COSs and one or more unconsolidated OC metrics to identify the optimal combination for the VM cluster. Any unconsolidated OC metrics that are included in the sequence of optimality comparisons may be OC metrics that are not involved in generating a partial COS and/or may be OC metrics used to generate one or more partial COSs. Furthermore, if multiple partial COSs are included in a given sequence, the partial COSs may be generated from distinct OC metrics or may be generated based on one or more of the same OC metrics. Partial COSs may be generated using weights or may be generated using the unweighted OC metric formulas, and may be generated using any kind of formula with any kind of mathematical operator(s).

To provide a simple example, the following OC metrics are calculated for each of A-B, B-G, and A-G: {cpu_interFabric_density_dev; cpu_intraFabric_density_avg; cpu_VM_opt_dev}. The user indicates that the sequence of optimality comparisons are as follows: first, compare a partial COS (∂COS), which is generated using the following formula that includes the weights for the OC metric components of the partial COS: ∂COS=(1/0.9)*cpu_interFabric_density_dev[combo]ₙₒᵣₘ+(1/0.7)*cpu_intraFabric_density_avg[combo]ₙₒᵣₘ. If there is a tie for highest-ranked compute node combination based on ∂COS, then the cpu_VM_opt_dev values are compared to determine which of the tied combinations is the “optimal” combination for VM cluster placement. To illustrate, the partial COS for each potential combination for VM cluster 230 is:
∂COS_{AB}=(1/0.9)*1.0+(1/0.7)*1.0=2.54
∂COS_{BG}=(1/0.9)*0.45+(1/0.7)*0.0=0.5
∂COS_{AG}=(1/0.9)*0.0+(1/0.7)*0.0=0.0

In this case, there is no need to compare cpu_VM_opt_dev, since there is no tie for highest-ranking compute node combination based on the ∂COS values, based on which, combination A-G is identified as the optimal placement for VM cluster 230.

### 4.4. Placement Model Application Across Fabrics

In a similar manner, optimal placements for VM clusters in higher-level groups of a compute node grouping hierarchy, such as failure domains and/or availability domains that group fabrics, may be determined. Specifically, in a manner similar to that described above, a subgroup-specific optimal VM cluster placement is identified for each subgroup at a given level of the compute node grouping hierarchy using a particular comparison scheme. These subgroup-specific optimal VM cluster placements are then compared using either the same or a different comparison scheme to identify a higher-level optimal VM cluster placement. According to various embodiments, computing system 100 also searches for a plurality of constraint-satisfying compute nodes that satisfy the constraints for VM cluster 230 within each of the other fabrics of system 100.

Specifically, according to various embodiments, in systems with multiple fabrics, such as fabrics 110, 120, and 130 of computing system 100, a fabric-specific optimal host compute node combination is determined for each fabric, as described above, and then the OC metrics for the fabric-specific optimal host compute node combination for each fabric are compared to identify a higher-level (such as failure domain-specific) optimal combination of compute nodes to host the VM cluster. The comparison scheme used to identify a higher-level optimal combination of compute nodes may be the same or different than the scheme used to identify fabric-specific optimal host compute node combinations for the various fabrics. For example, identification of fabric-specific optimal host compute node combinations is performed using a weighted comparison scheme with a first set of weights, and identification of a higher-level optimal combination of compute nodes to host the VM is performed using a weighted comparison scheme with a second set of weights or using a hybrid or ordered comparison scheme.

To illustrate, using the ordered comparison scheme based on the OC metrics {cpu_interFabric_density_dev; cpu_intraFabric_density_avg; cpu_VM_opt_dev} explained above, computing system 100 identifies combination A-G as the optimal placement for VM cluster 230 within fabric 110, referred to in this example as opt_combo_110. Using the same ordered comparison scheme, computing system 100 identifies a particular combination of compute nodes within fabric 120 as the fabric-specific optimal placement for VM cluster 230 (“opt_combo_120”), and another combination of compute nodes within fabric 130 as the fabric-specific optimal placement for VM cluster 230 (“opt_combo_130”). The non-normalized OC metrics determined for these fabric-specific optimal host compute node combinations are as follows:
opt_combo_110: {0.25; 0.47; 26.84}
opt_combo_120: {0.40; 0.63; 28.95}
opt_combo_130: {0.32; 0.55; 35.27}

In this example, the same ordered comparison scheme that was used to identify the fabric-specific optimal placements is also used to find the higher-level optimal placement. Thus, computing system 100 first ranks the combinations of compute nodes based on the cpu_intraFabric_density_avg metrics determined for the fabric-specific optimal placements, based on which computing system 100 identifies opt_combo_110 as highest-ranking combination and, as such, the optimal placement for VM cluster 230 for the higher-level device grouping.

### 4.5. Placement Types

The example illustrated in connection with flowchart 300 of FIG. 3 illustrates a new VM cluster placement, i.e., for a cluster that has not yet been established within system 100, based on a non-shuffling placement policy.

A non-shuffling placement policy places the one or more requested VMs without moving any VMs already placed within the target infrastructure. Thus, the placement considers only the needs of the current VM cluster in light of the existing shape of the infrastructure and VMs provisioned thereon, and does not impact existing VMs. A non-shuffling placement policy has the least disruption in services provided by the infrastructure. Application of a non-shuffling placement policy, according to techniques described herein, results in optimal placement for the VM cluster that is the subject of the current placement, but may not result in the most efficient or effective use of the computing system resources.

In contrast, a shuffling placement policy identifies an optimal placement for the target VM cluster as well as for all system resources by determining whether established VM clusters should be moved during the current placement operation. According to various embodiments, since shuffling placement has the potential to bring many VMs offline, such a placement is performed when system 100 otherwise experiences downtime, such as for application of software updates and/or during off-peak hours. However, the shuffling placement policy may be used to address computing systems that have VM configurations that are less-than optimal (such as in example node 114D that hosts the maximum number of very small VMs and has a high wastage index).

According to various embodiments, to effect a shuffling placement, one or more constraints and OCs, which would be applicable to the VM cluster placement during a non-shuffling placement, are considered to be inapplicable to the various VM clusters that will be affected by the shuffling VM cluster placement to reduce the processing power required to perform the placement. A shuffling placement may confine VM cluster re-placement to the original fabrics on which the VM clusters were placed at the time of the shuffling placement in order to reduce the complexity of the placement.

Computing system 100 may determine to apply a shuffling placement in any way, such as by: computing the resource wastage index for one or more target resources for nodes in the system and determining whether the resulting values satisfy shuffling criteria (such as there are over a threshold number of resource wastage index values over a threshold value, or an average of the resource wastage index values is over a threshold value, etc.); or determining that a count of non-shuffling placements, or of VMs placed within the system, since a last shuffling placement is over a threshold value; etc. When it is determined to apply a shuffling placement, a shuffling placement is scheduled to occur immediately or eventually. A shuffling placement that is scheduled for the future may not be associated with a specific target VM cluster to change or add, but is instead configured to identify optimal placements for existing VMs in the system.

In addition to using a non-shuffling or shuffling placement policy, a VM cluster placement request may request various types of VM placement, including a new placement (as illustrated above), an incremental placement, or a scaling placement.

### 4.5.1. Incremental Placement

An incremental placement request adds one or more VMs to a VM cluster that is established at the time of the request. In the case of an incremental VM cluster placement, only combinations of potential host nodes (including the host nodes that already host the established VMs of the cluster) on the fabric that includes the established VMs is considered for VM cluster placement based on the constraint that a VM cluster cannot span multiple fabrics.

### 4.5.2. Scaling Placement

A scaling placement request adjusts the amount of one or more resources allocated for a VM cluster that is established at the time of the request. A scaling placement may adjust the allocated resources up or down. If a scaling placement fails for one or more of the VMs of the target VM cluster (e.g., the resources of a particular node on which the VM to be scaled resides does not have sufficient resources to accommodate the up-scale requirements of the VM), the scaling placement request is considered to be an incremental request (in the case that the scaling placement has failed for only one VM) or a new placement request (in the case that the scaling placement has failed for all VMs of the target VM cluster).

### 5. Implementing VM Cluster Placement

Returning to a discussion of flowchart 300 of FIG. 3, at step 310, the VM cluster is automatically provisioned on the particular combination of compute nodes. For example, computing system 100 automatically provisions VM cluster 230 on compute nodes 114A and 114G based on the hybrid comparison scheme, as illustrated above.

According to various embodiments, a workflow for actions required to affect the VM cluster placement on the identified combination of compute nodes is derived in a proper dependent graph, and the actions are executed from the graph to realize the required placement. To illustrate, computing system 100 derives workflow steps for the VM cluster placement based on the difference between the current state of the system (“S1”) and the state of the system reflecting the optimal VM cluster placement determined for the target VM cluster (“S2”). For example, computing system 100 derives the workflow steps for placing VM cluster 230 on fabric 110 in the initial state S1 depicted in FIG. 2A, on compute node combination A-G (S2) as follows:
Step 1) Allocate resources required for VM 230(A), including 30 CPUs, on node 114A.
Step 2) Provision VM 230(A) on node 114A.
Step 3) Allocate resources required for VM 230(B), including 30 CPUs, on node 114G.
Step 4) Provision VM 230(B) on node 114G.

Implementation of Steps 1-4 above will change the state of system 100 from S1 to S2, thereby implementing the identified optimal placement for VM cluster 230. According to various embodiments, generation of the workflow steps to move system 100 from S1 to S2 is implemented by a plan generation module, which may or may not be within system 100. For example, the plan generation module may be implemented as a service accessible by system 100 via a network, and system 100 generates the workflow steps by requesting the workflow steps from the plan generation service.

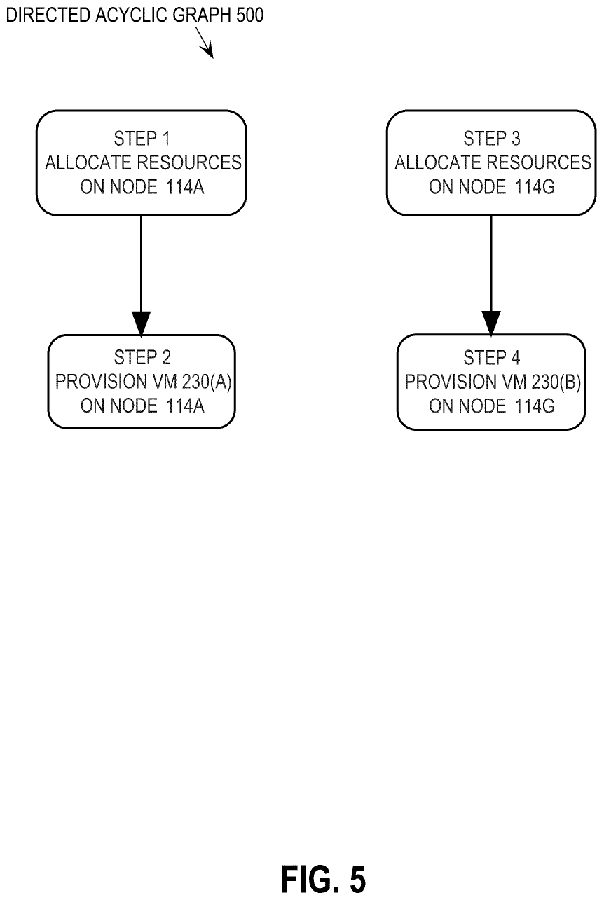

According to various embodiments, computing system 100 generates a workflow proper dependent graph based on the optimal placement determined for a given VM cluster, based on which the system implements the optimal VM cluster placement. To illustrate, computing system 100 constricts a directed acyclic graph (DAG), such as DAG 500 of FIG. 5, based on the workflow steps derived for the VM cluster placement. To illustrate, DAG 500 depicts that Step 1 of the workflow steps for placement of VM cluster 230 included above must be performed before Step 2 (“Step Sequence 1-2”), and Step 3 must be performed before Step 4 (“Step Sequence 3-4”). However, the lack of any other dependencies indicates that Step Sequence 1-2 may be performed in parallel with Step Sequence 3-4.

While the example of VM cluster 230 placement results in a relatively simple DAG 500, the steps may be far more complicated, especially when the placement is a shuffling placement as described in detail above. Generation of a DAG for the workflow steps requires iterating through the complete hierarchy, diffing each of objects at a resource level, noting any difference as an actionable item part of the workflow. Once the abstract workflow definition has been established, the workflow steps are mapped to actionable execution steps (e.g., “create vm (vm object)”), which can be implemented by computing system 100 to realize the target VM cluster in the identified optimal combination of host compute nodes.

### 6. Database System Overview

According to various embodiments, one or more VM clusters (including a target VM cluster for a placement decision) in a target computing system each implements a shared database cluster application, and one or more of the constraints and/or OCs applicable to the target VM cluster are associated with the cluster based on the cluster implementing a database-type application. Enterprise class database applications have specialized requirements (such as a VM_max for host nodes, and a minimum storage capacity requirement for storage nodes in the target fabric), and application of the placement model described herein facilitates placement of VM clusters implementing such applications based on the specialized requirements.

A database management system (DBMS), such as is implemented by a shared database cluster application, manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g., work stations, personal computers) that are interconnected via a network, as described above. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance” A database server may comprise multiple database instances, some or all of which are running on separate computers, including separate server blades.

### 7. Hardware Overview

An application, such as an application running on a computing device of system 100 that implements techniques described herein, comprises a combination of software and allocation of resources from the computing device. Specifically, an application is a combination of integrated software components and an allocation of computational resources, such as memory, and/or processes on the computing device for executing the integrated software components on a processor, the combination of the software and computational resources being dedicated to performing the stated functions of the application.

One or more of the functions attributed to any process described herein, may be performed any other logical entity that may or may not be depicted in FIG. 3, according to one or more embodiments. In some embodiments, each of the techniques and/or functionality described herein is performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

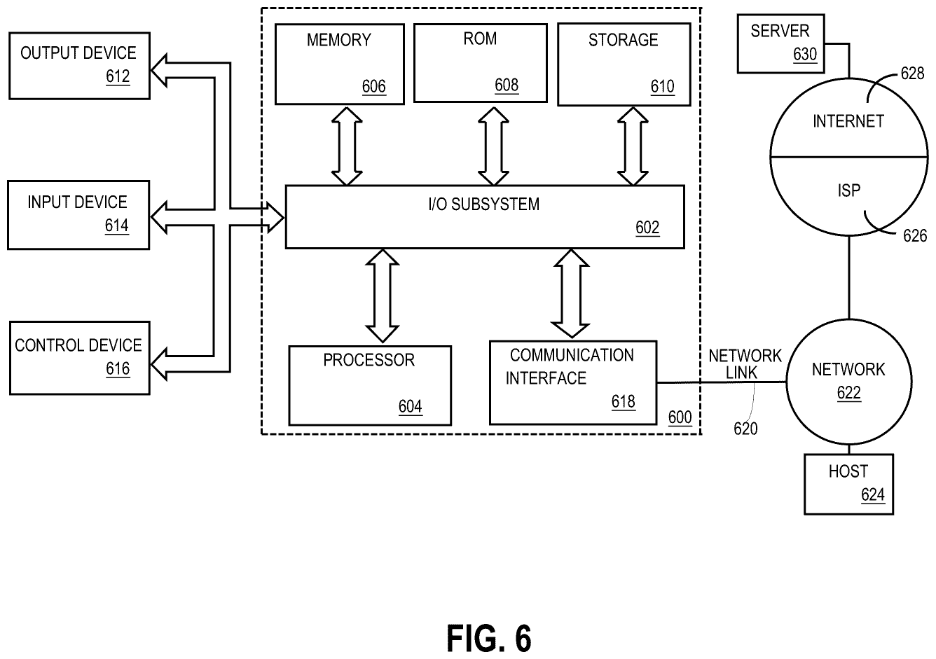

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world-wide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 8. Software Overview

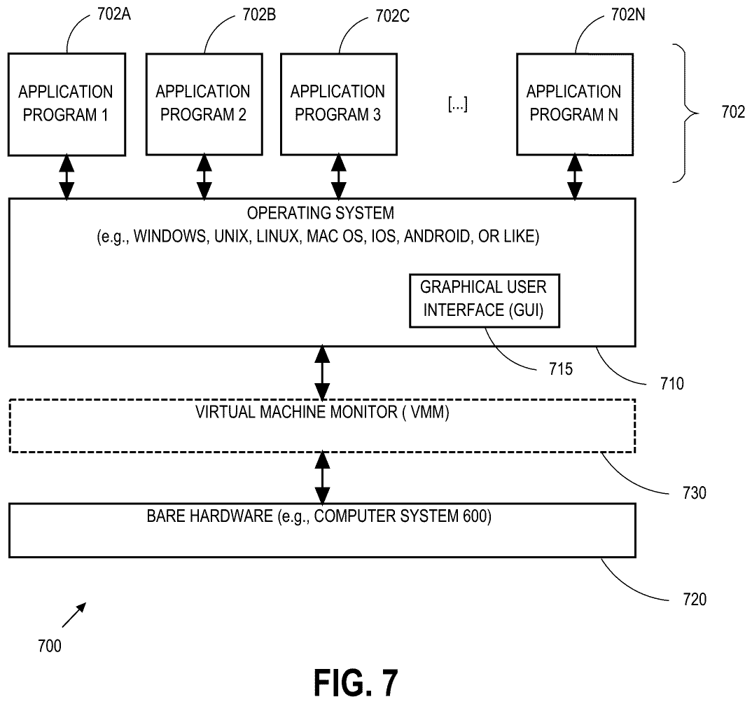

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### 9. Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
provisioning a virtual machine (VM) cluster, comprising a plurality of VMs, within a computing system that comprises a particular set of computing devices by:
identifying a plurality of constraint-satisfying computing devices, of the particular set of computing devices, that satisfy one or more constraints for the VM cluster;
wherein each of a plurality of combinations of computing devices, within the plurality of constraint-satisfying computing devices, accommodate the plurality of VMs;
producing a plurality of combination-specific sets of optimization criteria (OC) metrics by, for each combination of computing devices of the plurality of combinations of computing devices:
producing a combination-specific set of OC metrics by, for each OC of a set of OCs applicable to the VM cluster, computing a metric that represents said each OC based on one or more characteristics of said each combination of computing devices;
ranking the plurality of combinations of computing devices based on the plurality of combination-specific sets of OC metrics;
identifying a particular combination of computing devices, of the particular set of computing devices, as an optimal combination of computing devices for placement of the VM cluster based on the particular combination of computing devices being a highest-ranked of the plurality of combinations of computing devices; and
automatically provisioning the VM cluster on the particular combination of computing devices.

2. The computer-implemented method of claim 1, wherein the computing system comprises a plurality of sets of computing devices that includes the particular set of computing devices, the method further comprising:
identifying a plurality of set-optimal combinations of computing devices by, for each set of computing devices of the plurality of sets of computing devices, identifying a set-optimal combination of computing devices based on the set-optimal combination of computing devices being a highest-ranked combination of computing devices based on combination-specific sets of OC metrics determined for combinations of computing devices within said each set of computing devices;
wherein the particular combination of computing devices is the set-optimal combination of computing devices for the particular set of computing devices; and
identifying the particular optimal combination of computing devices as a multiset-optimal combination of computing devices, from the plurality of set-optimal combinations of computing devices, based on the multiset-optimal combination of computing devices being a highest-ranked combination of computing devices based on combination-specific sets of OC metrics determined for the plurality of set-optimal combinations of computing devices;
wherein said automatically provisioning the VM cluster on the particular combination of computing devices is performed responsive to identifying the particular combination of computing devices as the multiset-optimal combination of computing devices.

3. The computer-implemented method of claim 2, wherein:
for each set of computing devices, of the plurality of sets of computing devices:
said each set of computing devices is a set of tightly-interconnected computing devices, and
connections between devices of said each set of computing devices are configured to allow remote direct memory access (RDMA) requests; and
connections between sets of computing devices, of the plurality of sets of computing devices, are configured to disallow RDMA requests.

4. The computer-implemented method of claim 1, wherein:
the VM cluster is a first VM cluster with a first cardinality of VMs;
the method further comprises provisioning a second VM cluster, comprising a second plurality of VMs with a second cardinality that is different than the first cardinality, within the computing system.

6. The computer-implemented method of claim 1, wherein:
each OC of the set of OCs applicable to the VM cluster represents an optimization goal for one of: the computing system, an application associated with the VM cluster, the VM cluster, or a customer associated with the VM cluster;
a metric is computed for each OC of the set of OCs applicable to the VM cluster based on a formula that represents the OC, the formula using one or more of: one or more attributes of the VM cluster, one or more attributes of computing devices in a target combination of computing devices, or one or more attributes of the particular set of computing devices.

7. The computer-implemented method of claim 6, further comprising:
wherein a first formula (a) represents a particular OC of the set of OCs applicable to the VM cluster, (b) is used to compute a particular metric for the particular OC;
selecting the first formula to compute the particular metric for the particular OC based on the first formula being associated with one or more of: the customer associated with the VM cluster, the application associated with the VM cluster, or the particular set of computing devices.

8. The computer-implemented method of claim 1, wherein a particular OC, of the set of OCs applicable to the VM cluster, is based on a maximum number of VMs that may be placed on a given computing device of the computing system.

9. The computer-implemented method of claim 8, wherein the VM cluster is configured to host a shared database cluster application, and the particular OC is applicable to the VM cluster based on the type of the shared database cluster application.

10. The computer-implemented method of claim 1, wherein a particular OC, of the set of OCs applicable to the VM cluster, is based on a standard deviation of a measurement of density of resources within computing devices of the particular set of computing devices.

11. The computer-implemented method of claim 1, wherein:
each constraint of the one or more constraints for the VM cluster is associated with the VM cluster based on one or more of: the constraint being a default constraint for the computing system, a type of an application associated with the VM cluster, an attribute of the VM cluster, or a customer associated with the VM cluster; and
each OC of the set of OCs applicable to the VM cluster is associated with the VM cluster based on one or more of: the constraint being a default constraint for the computing system, the type of the application associated with the VM cluster, an attribute of the VM cluster, or the customer associated with the VM cluster.

12. The computer-implemented method of claim 1, wherein each constraint of the one or more constraints for the VM cluster is based on one or more of: a type of an application associated with the VM cluster, an attribute of the VM cluster, an attribute of one or more computing devices of a target combination of computing devices, an attribute of a storage device in the particular set of computing devices, or an attribute of the particular set of computing devices.

13. The computer-implemented method of claim 1, wherein said ranking the plurality of combinations of computing devices based on the plurality of combination-specific sets of OC metrics comprises applying, to one or more corresponding OC metrics of the plurality of combination-specific sets of OC metrics: a weighted comparison scheme, an ordered comparison scheme, or a hybrid comparison scheme.

14. The computer-implemented method of claim 1, further comprising:
provisioning a second VM cluster comprising a second plurality of VMs that were established within the particular set of computing devices at the time of said provisioning the second VM cluster,
wherein said provisioning the second VM cluster comprises provisioning one or more VMs, other than the second plurality of VMs, for the second VM cluster.

15. The computer-implemented method of claim 1, wherein:
at the time of said provisioning the VM cluster, a second set of computing devices of the computing system hosts a second VM cluster;
said provisioning the VM cluster comprises moving at least one VM of the second VM cluster to a computing device other than the second set of computing devices.

16. The computer-implemented method of claim 1, further comprising:
provisioning a second VM cluster comprising a second plurality of VMs that were established within the particular set of computing devices at the time of said provisioning the second cluster,
wherein said provisioning the second VM cluster comprises changing an amount of resources allocated to one or more VMs of the second plurality of VMs.

17. One or more non-transitory computer-readable media storing instructions that, when executed by one or more processors, cause:
provisioning a virtual machine (VM) cluster, comprising a plurality of VMs, within a computing system that comprises a particular set of computing devices by:
identifying a plurality of constraint-satisfying computing devices, of the particular set of computing devices, that satisfy one or more constraints for the VM cluster;
wherein each of a plurality of combinations of computing devices, within the plurality of constraint-satisfying computing devices, accommodate the plurality of VMs;
producing a plurality of combination-specific sets of optimization criteria (OC) metrics by, for each combination of computing devices of the plurality of combinations of computing devices:
producing a combination-specific set of OC metrics by, for each OC of a set of OCs applicable to the VM cluster, computing a metric that represents said each OC based on one or more characteristics of said each combination of computing devices;
ranking the plurality of combinations of computing devices based on the plurality of combination-specific sets of OC metrics;
identifying a particular combination of computing devices, of the particular set of computing devices, as an optimal combination of computing devices for placement of the VM cluster based on the particular combination of computing devices being a highest-ranked of the plurality of combinations of computing devices; and
automatically provisioning the VM cluster on the particular combination of computing devices.

18. The one or more non-transitory computer-readable media of claim 17, wherein:
the computing system comprises a plurality of sets of computing devices that includes the particular set of computing devices; and
the instructions further comprise instructions that, when executed by one or more processors, cause:
identifying a plurality of set-optimal combinations of computing devices by, for each set of computing devices of the plurality of sets of computing devices, identifying a set-optimal combination of computing devices based on the set-optimal combination of computing devices being a highest-ranked combination of computing devices based on combination-specific sets of OC metrics determined for combinations of computing devices within said each set of computing devices;
wherein the particular combination of computing devices is the set-optimal combination of computing devices for the particular set of computing devices; and
identifying the particular optimal combination of computing devices as a multiset-optimal combination of computing devices, from the plurality of set-optimal combinations of computing devices, based on the multiset-optimal combination of computing devices being a highest-ranked combination of computing devices based on combination-specific sets of OC metrics determined for the plurality of set-optimal combinations of computing devices;
wherein said automatically provisioning the VM cluster on the particular combination of computing devices is performed responsive to identifying the particular combination of computing devices as the multiset-optimal combination of computing devices.

19. The one or more non-transitory computer-readable media of claim 18, wherein:
for each set of computing devices, of the plurality of sets of computing devices:
said each set of computing devices is a set of tightly-interconnected computing devices, and
connections between devices of said each set of computing devices are configured to allow remote direct memory access (RDMA) requests; and
connections between sets of computing devices, of the plurality of sets of computing devices, are configured to disallow RDMA requests.

20. The one or more non-transitory computer-readable media of claim 17, wherein:
first hardware, of a first computing device of the particular combination of computing devices, is heterogeneous from second hardware of a second computing device of the particular combination of computing devices; and
computing at least one metric of the combination-specific set of OC metrics for the particular combination of computing devices comprises determining a first performance metric based on the first hardware and a second performance metric based on the second hardware.
